(19) United States
(12) Patent Application Publication
(10) Pub. No.: US 2010/0039392 A1
(43) Pub. Date: Feb. 18, 2010

(54) CONDUCTIVE FINGERNAIL

(75) Inventors: James Pratt, Round Rock, TX (US); Sarah Everett, Austin, TX (US); Marc Sullivan, Austin, TX (US)

Correspondence Address: AT&T Legal Department - T&W;Attn: Patent Docketing, Room 2A-207, One AT&T Way, Bedminster, NJ, 07921, US

(73) Assignee: AT&T Intellectual Property I, L.P., Reno, NV (US)

(21) Appl. No.: 12/192,658

(22) Filed: Aug. 15, 2008

(51) Int. Cl. G06F 3/041

(52) U.S. Cl. 345/173

(57) ABSTRACT

A device and attachment connected to a user's fingernail that can be employed to interact with a conductive touch screen is provided. Specifically, the device is made from a conductive material and provides conductivity to the screen when in contact. The device is connected to or placed on the user's fingernail, or worn on top of the user's finger or glove. When the user touches the conductive touch screen via the device on the finger, a disturbance in capacitance is created and accordingly the presence and/or location of the finger on the screen can be detected.

### BACKGROUND

Electronic devices such as cell phones and PDAs (personal digital assistants) are being extensively used for most any application and user-interaction with the device is rapidly evolving. The user can employ the electronic device to communicate with another user, listen to music, and/or watch a video. Different methods are provided to a user to communicate with electronic devices, however simple and easy-to-use interfaces are gaining popularity.

Various audio/visual techniques, including touch screens, are employed to facilitate user-interaction with an electronic device, such as cellular phones, media players, navigation systems, ATMs (Automated Teller Machine), tablet PCs (personal computers), etc. Device designers are on the lookout for new techniques that make devices more user-friendly and receptive to the user's needs. Touch screens are extremely easy-to-use input devices that enable users to effectively communicate with a computer. The user can simply touch an icon or button on the screen to make a selection and/or perform an action. Touch screens are easier to use as compared to other input devices such as keyboards, joysticks or mice, especially for untrained computer users. Further, device designers can reduce the size of the device by employing touch screens as an input and output device. Touch screens can be employed by various devices and applications including point-of-sale, point-of-information, process control, kiosks, gaming, medical instrumentation, public information displays, industrial control systems, etc.

Typically, capacitive sensing methods are employed by touch screens to determine if a user is touching the screen based on electrical disturbance. Hence, the electrical characteristics of the touching object are important. Human skin is a conductive material and the capacitive sensor can thus detect its presence. Employing a capacitive touch technology in the touch screen facilitates identification that a user has touched the portable device and reduces false alarms due to a touch by other non-conductive objects. Moreover, sensors that employ capacitive touch technology differentiate between a touch by a conductive material and a non-conductive material and accordingly reduce errors in reading human touch.

However, skin sensitive touch screens are inconvenient for persons wearing gloves, or with long fingernails. Specifically, fingernails are not conductive, so users with long fingernails contort their fingers and put the device at an odd angle in order to touch icons on the screen. Further, it is even more difficult for a user with long fingernails to use a touch screen on stationary devices, such as ATM (Automated Teller Machine) since the position of the device and/or touch screen cannot be changed. This can lead to user frustration. Furthermore, fingers are typically broad and it is difficult to select a single point on the screen with the touch of a finger. Thus, it is difficult to achieve precision while employing a skin sensitive touch screen with a finger.

### SUMMARY

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to present some concepts of the specification in a simplified form as a prelude to the more detailed description that is presented later.

The systems and methods disclosed herein, in one aspect thereof, can facilitate input of data on a conductive touch screen by employing a conductive device. In particular, the conductive device can include a pointing device that provides conductivity to the conductive touch screen. The capacitive sensors employed by the touch screen sense contact made by the pointing device based on a change in capacitance at the point of contact. Data associated with the contact made by the pointing device can be processed to determine the location of contact on the touch screen and accordingly perform an appropriate action. Further, the pointing device is made of most any conductive material, such as, but not limited to silicon or a conductive metal. In one example, the pointing device can be coated with a layer of a conductive material.

In accordance with another aspect, the conductive device can include an attaching device that connects the pointing device to a finger or fingernail of a user. The attaching device employs most any permanent, semi-permanent or temporary technique to fasten the pointing device to a user (e.g. by clipping the pointing device to the user's fingernail). Typically, one end of the attaching device can be connected to the base of the pointing device and the other end can be connected to the user. Once connected, the user can interact with the conductive touch screen by placing his/her fingernail on the touch screen such that the pointing device is in contact with the screen.

Another aspect of the subject innovation comprises a conductive apparatus that can be worn by user to facilitate interaction with an electronic device via a conductive touch screen. In particular, the conductive touch screen employs one or more capacitive sensors to detect the presence of a conductive element. The user can wear the conductive apparatus over one or more fingers to enter information on the touch screen. When the user touches the touch screen with a finger, the conductive apparatus on the finger can generate a disturbance in capacitance and accordingly the presence and/or location of the finger on the touch screen can be detected. According to yet another aspect, the conductive apparatus can be worn on top of a glove and/or can be employed by machines (e.g. robotic arms, assistive devices) that communicate with the conductive touch screen.

Still another aspect of the system comprises a conductive fingernail that enables a user to interact with a touch screen that employs capacitive sensors. The conductive fingernail is a fake fingernail that can exhibit conductive properties and can be permanently or semi permanently attached to the user's finger. According to another aspect, conductive fingernail paint can also be applied to a user's fingernail to input information to the electronic device via the touch screen. When the conductive fingernail is in contact with the touch screen, a change in capacitance is generated due to the conductivity provided by the conductive fingernail. The change in capacitance can be sensed and the presence and/or location of the conductive fingernail on the touch screen can be detected.

Yet another aspect of the disclosed subject matter relates to a method that enables a user to interact with an electronic device via a capacitive touch screen. A conductive device is connected to a user, for example, attached to a user's fingernail. Further, the conductive touch screen is touched by employing the conductive device attached to the fingernail. Furthermore, conduction data associated with the touch is sensed and a location of the device on the touch screen is determined based in part on the conduction data. Additionally, a selection can be made and/or an action can be performed based on the location of the device.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates an example apparatus that can be employed to enter information onto a conductive touch screen in accordance with the subject disclosure.

FIG. 2 illustrates an example apparatus that can be attached to a user to interact with a skin sensitive touch screen, according to an aspect of the subject specification.

FIG. 3 illustrates an example system wherein a conductive fingernail can be employed by a user to interact with a phone in accordance with an aspect of the disclosure.

FIG. 4 illustrates example pointing devices that can be employed by a user while interacting with an electronic device, according to an aspect of the subject innovation.

FIG. 5 illustrates an example conductive apparatus that can be worn by user to interact with an electronic device in accordance with the subject innovation.

FIG. 6 illustrates example conductive fingernails that can be employed by user to interact with an electronic device in accordance with an aspect of the disclosed subject matter.

FIG. 7 illustrates an example methodology that can be employed to interact with an electronic device via a capacitive touch screen, according to an aspect of the disclosed subject innovation.

FIG. 8 illustrates an example methodology that can be employed to receive data from a conductive fingernail in contact with a touch screen in accordance with an aspect of the disclosed subject innovation.

FIG. 9 illustrates is a schematic block diagram depicting a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Furthermore, various embodiments are described herein in connection with an electronic device that employs a touch screen. An electronic device can also be called a system, subscriber unit, subscriber station, mobile station, mobile, remote station, remote terminal, access terminal, user terminal, terminal, wireless communication device, user agent, user device, or user equipment (UE). Further, the electronic device can include electronic systems, such as, but not limited to a cellular telephone, a cordless telephone, a Session Initiation Protocol (SIP) phone, a wireless local loop (WLL) station, a personal digital assistant (PDA), a handheld electronic device, a laptop, an automated teller machine (ATM), a computing device, a media player, a media recorder, a camera, etc., or a combination thereof. Additionally, the terms “touch screen”, “conductive touch screen”, “capacitive touch screen”, “skin sensitive touch screen” and “screen” are used interchangeably herein and are intended to refer to a screen that detects touch based on conduction of the object touching the screen.

Various electronic devices employ touch screen to facilitate communication between a user and the device. Typically, skin sensitive touch screens can be employed to receive input from a user. Specifically, a user can employ a finger to touch the screen on an icon that can select an option and/or perform an action. However, non-conductive materials, such as, but not limited to, a fingernail cannot be employed to enter information on the touch screen.

Systems and/or methods are presented herein that can enable people with long fingernails, disabled people that employ assistive devices to interact with a device, or machines, to employ a skin sensitive touch screen with ease. A device that would provide conductivity to the touch screen and enable a user to enter information into an electronic device is provided herein.

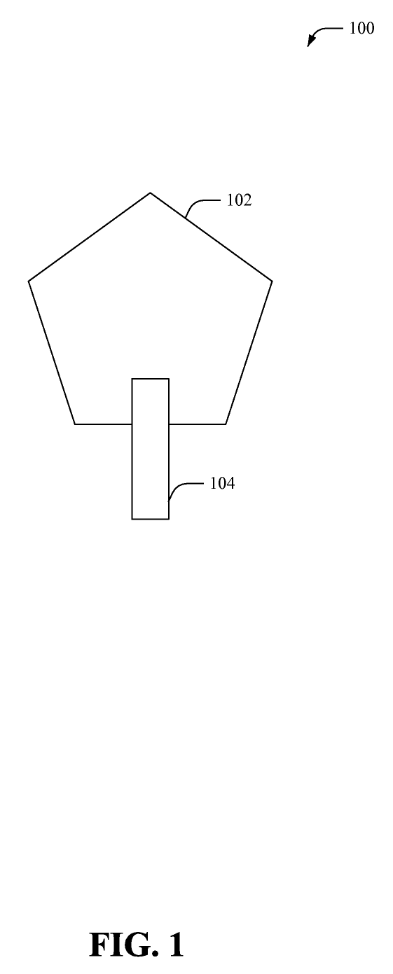

Referring initially to FIG. 1, there illustrated is an example apparatus 100 that can be employed to enter information onto a conductive touch screen in accordance with the subject disclosure. In one aspect, the apparatus 100 can be attached permanently or temporarily to a user's fingernail. Typically, apparatus 100 can be employed to communicate with an electronic device via a conductive touch screen. The electronic device can include, but is not limited to a cellular phone, a media player, a GPS navigator, a PDA, a gaming module, a radio player, a media recorder, an ATM, a self-service kiosk, etc. or a combination thereof.

The apparatus 100 typically includes a pointing device 102 that can enable a user to interact with the conductive touch screen. It can be appreciated that although the pointing device 102 is depicted as a pentagon in the FIG. 1, a pointing device 102 of most any shape and/or size can be employed. According to an aspect, one end (e.g. base) of the pointing device 102 can be connected to an attaching device 104. Further, the other end (e.g. tip) of the pointing device 102, for example, the end that can be employed to touch the conductive screen, can be made narrow, such that precision can be improved. It can be appreciated that tips of different widths can be employed based on an application that the pointing device 102 is used for. For example, in an industrial environment wherein an accurate input is required, a pointing device 102 with an extremely narrow width at the tip can be employed.

The pointing device 102 can provide conductivity to the conductive touch screen. In an example, if a user wants to select an icon on a touch screen, the user can touch the pointing device 102 to the icon on the touch screen. Since the pointing device 102 can provide conductivity, the capacitive sensors employed by the touch screen can collect information associated with the touch by the pointing device 102. Based on the data collected by the sensors, a processing unit in the electronic device can determine the location of the touch and accordingly perform an appropriate action. Various conductive materials can be utilized to make the pointing device 102, such as, but not limited to silicon or a conductive metal. It can be appreciated that the pointing device 102 can be coated with a layer of a conductive material.

The attaching device 104 can be employed to connect the pointing device 102 directly to a finger or fingernail of a user. It can be appreciated that the attaching device 104 is not limited to connecting the pointing device 102 to a user's finger and/or fingernail, but can also be employed to connect the pointing device 102 to a machine, for example, a robotic arm, that desires to communicate with the electronic device. Further, the attaching device 104 can be employed to connect the pointing device 102 to an assistive device that enable a disabled person to use a conductive touch screen.

According to an aspect, the attaching device 104 can clip the pointing device 102 to a user's fingernail. The attaching device 104 is not limited to employ a clipping technique but can employ most any permanent, semi-permanent or temporary technique to connect the pointing device 102 to a user. Typically, one end of the attaching device 104 can be connected to the pointing device 102 and the other end can be connected to a user. The user can include, but is not limited to, a human operator, an assistive device and/or a robot. According to an aspect, one end of the attaching device 104 can be connected to a user and pointing devices 102 of different shapes and/or sizes can be attached at the other end.

In one example, a user can attach apparatus 100 to one or more of their fingernails to employ a cellular phone with a skin sensitive touch screen. The user can clip one end of the attaching device 104 to a fingernail. Further, the other end of the attaching device 104 can be connected to a pointing device 102. The user can then touch the conductive touch screen of the cellular phone with apparatus 100 that is attached to his/her fingernail. Specifically, the user can touch the pointing device 102 to an area on the touch screen, for example, an icon, a key or a button. The pointing device 102 can provide conductivity to the touch screen at the point of contact. Based on the data collected by one or more circuits associated with the touch screen, the cellular phone can detect the touch of the user can accordingly perform an action and/or activate a process.

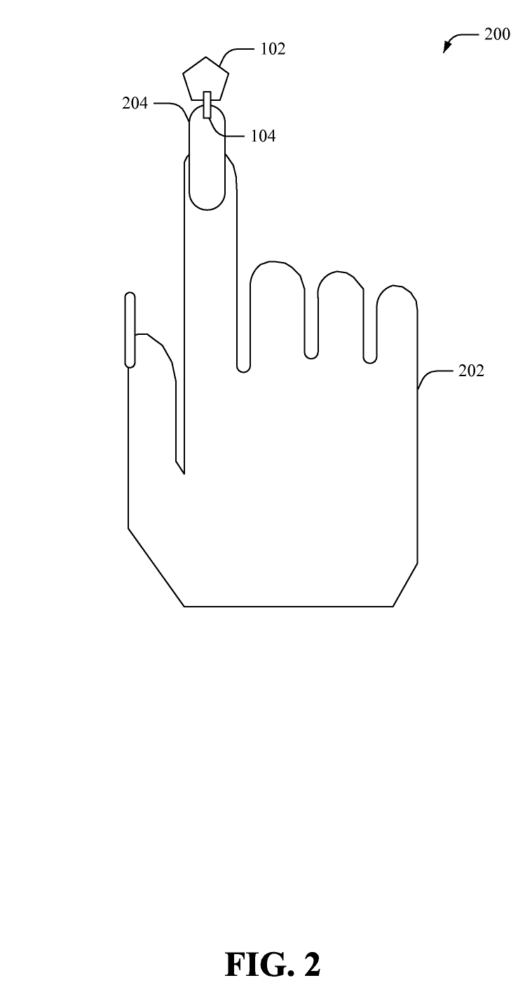

Referring now to FIG. 2, illustrated is an exemplary apparatus 200 that can be worn by a user to interact with a skin sensitive touch screen, according to an aspect of the subject specification. In one aspect, the skin sensitive touch screen (not shown)can employ capacitive sensors that can sense a touch on the screen based on electrical conductivity. Thus, the electrical characteristics of the touching object are important. Human skin is a conductive material and the capacitive sensor can detect its presence. However, fingernails do not conduct electricity and cannot be employed to enter information on a skin sensitive touch screen. Long fingernails prevent users from touching the touch screen with skin on their fingers. It can be appreciated that the pointing device 102 and the attaching device 104 can include functionality, as more fully described herein, for example, with regard to apparatus 100.

According to an aspect, an apparatus can be connected to the user's hand 202, for example on a fingernail 204 (as shown) or on the finger itself (not shown). The apparatus can include a pointing device 102 and an attaching device 104 that can help the user interact with a touch screen. In particular, one end of the attaching device 104 can be connected to the user's fingernail 204. It can be appreciated that although only one apparatus 200 connected to the index finger is depicted in the figure; an apparatus 200 can be connected to any finger on either the left or the right hand of the user. Specifically, the attaching device 104 can be connected to any finger on the user's hand. Additionally, a user can connect one or more attaching devices 104 on one or more fingers. For example, while employing multi-input conductive touch screens, the user can connect an attaching device 104 connected to a pointing device 102 to the fingernail of the index finger and a disparate attaching device 104 connected to a disparate pointing device 102 to a fingernail of the thumb. Thus, the user can easily move, grab and/or pinch objects on the screen.

In one embodiment, the user can easily remove the attaching device 104. Thus, the user can connect the attaching device 104 to a fingernail 204 only when communication with a skin sensitive touch screen is desired. Further, the user can also change the pointing device 102 connected to attaching device 104 with another pointing device that has a different size and/or shape. For example, when a user has to choose between closely spaced and/or small icons on a touch screen, the user can employ a pointing device with a narrow tip (pointer), else the user can employ pointing device with a wide pointer.

As an example, when a user is interacting with an ATM, the user can connect one end of the attaching device 104 to a fingernail 204 and connect a suitable pointing device 102 to the other end of the attaching device 104. Once connected, the user can touch the screen with the pointing device 102 to input information. It can be appreciated that when the user has connected the apparatus 100 to a finger or the fingernail 204, the user can still press buttons and/or keys, for example, on a keypad of the ATM. When the user has completed all transactions on the ATM (e.g. withdrawing cash and/or depositing a check), the user can remove the attaching device 104.

In an aspect, the attaching device 104 can be permanently connected to a fingernail 204 or finger of the user. Thus, the user can simply connect a pointing device 102 whenever interaction with a skin sensitive touch screen is desired. Typically, the user can select between different shapes and/or sizes of pointing devices based on the precision required on the touch screen. As an example, a user having broad fingers can employ the pointing device 102 to select between small and/or closely spaced elements on the touch screen. Further, according to one aspect, the apparatus 200 or pointing device 102 can be permanently implanted in a user's finger.

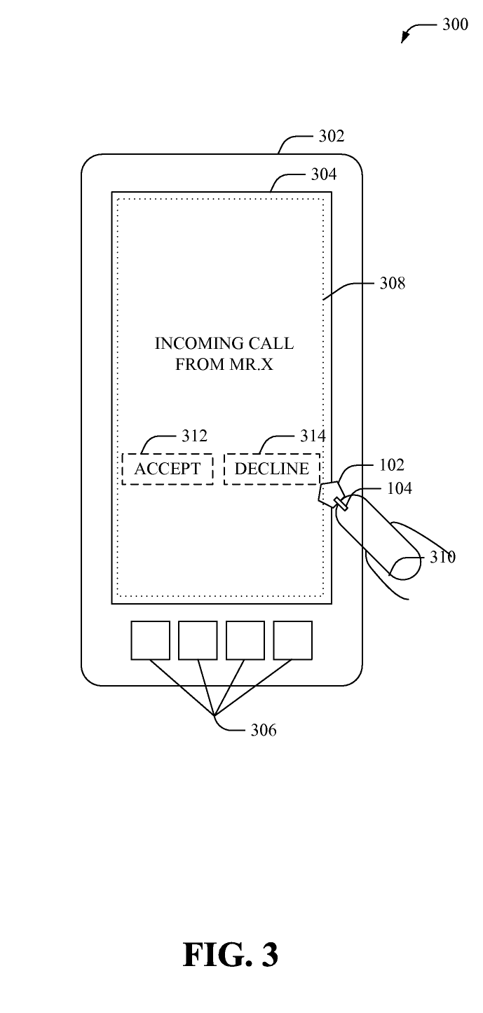

FIG. 3 illustrates an example system 300 wherein a conductive fingernail apparatus can be employed by a user to interact with a phone 302 in accordance with an aspect of the disclosure. By way of example and not limitation, the phone 302 can include a cellular telephone, a cordless telephone, a wired telephone, a Session Initiation Protocol (SIP) phone, a wireless local loop (WLL) station, a personal digital assistant (PDA) and the like. Although system 300 illustrates employing a conductive fingernail apparatus to interact with a phone 302, it can be appreciated that the conductive fingernail apparatus can be employed to interact with most any electronic device via a conductive touch screen. Further, it can be appreciated that the pointing device 102 and the attaching device 104 can include functionality, as more fully described herein, for example, with regard to apparatus 100 and 200.

The phone 302 can include a touch screen 302 and a set of keys 304 that facilitate user interaction. Typically, the touch screen 302 can employ one or more sensors 308 that can be located below the touch screen 302 to collect data associated with touch, for example, by the pointing device 102. In addition, it can be appreciated that the sensors 308 can be placed anywhere on the portable device in a manner that is transparent to the user. In one example, the sensors 308 can be located in a dedicated area that is visible to the user. As an example, “Touch here to accept incoming call” or “Touch here to reject incoming call” or the like can be written over the dedicated area, such that the user can easily identify where to touch the phone 302.

In an aspect, sensors 308 collect data that enables the phone 302 to determine whether the user is currently touching the phone 302, for example, via the pointing device 102. Further, the location of the touch can also be determined based on data from sensors 308. The sensors 308 can employ the electrical conduction of the pointing device 102, as employed in capacitive touch technologies, to determine that a user is touching the phone 302. According to an aspect, sensors 308 can employ capacitive sensing, wherein the capacitive sensor 308 can includes a simple supporting sheet of glass with a conductive coating on one side. A printed circuit pattern can be employed around the outside of a viewing area. The printed circuit pattern can set a charge across the surface, which is disturbed by a conductive material, such as, the pointing device 102 touching the sensor 308.

In one example, the touch screen 304 can be coated with a material, (e.g. indium tin oxide) that conducts a continuous electrical current across the sensors 308. Thus, the sensors 308 exhibit a precisely controlled field of stored electrons in both the horizontal and vertical axes. Typically, the pointing device 102 is an electrical device, which has stored electrons and thus exhibits capacitance. When the pointing device 102 touches the touch screen 304, the capacitance field of the sensors 308 can be modified. According to an aspect, one or more electronic circuits can measure a resultant distortion in a sine wave characteristics of the capacitance field of the sensors 308 and can send associated data to a controller and/or processor for mathematical processing. The controller and/or processor can determine a location where the pointing device 102 has touched the touch screen 102. Further, based on the location, the controller and/or processor can select an option and/or perform an action.

Typically, a user can employ a conductive fingernail apparatus to interact with the phone 302. According to an aspect, the user can connect an attaching device 104 to a fingernail 310. It can be appreciated that the attaching device 104 can be permanently or temporarily connected to the fingernail 310. Based on the amount of precision required to interact with the touch screen 304, the user can select and connect a pointing device 102 to the attaching device 104. When the user touches the conductive touch screen 304, the pointing device 102 can be in contact with the touch screen 304 and since the pointing device 102 is conductive, the sensors 308 can detect a touch by the pointing device 102.

As an example, a user can receive an incoming call on the phone 302. The conductive touch screen 304 can be employed to convey information that the user is currently receiving an incoming call (as shown in FIG. 3). In addition, an audio ring or vibration can also be employed to notify the user of the incoming call. Further, the touch screen 304 can also display a number and/or name of person who is calling the user. Furthermore, the touch screen 304 can display an icon 312 for accepting the call and an icon 314 for declining the call. The user can connect the conductive fingernail apparatus (e.g. the attaching device 104 and the pointing device 102) to a fingernail 310 (if not already connected) and touch the screen 304 to select a desired icon. For example, when the user wants to accept the call, the user can touch the screen on the accept call icon 312, such that, the pointing device 102 is in contact with the icon 312. Similarly, when the user would like to decline the call, the user can touch the pointing device 102 to the decline call icon 314.

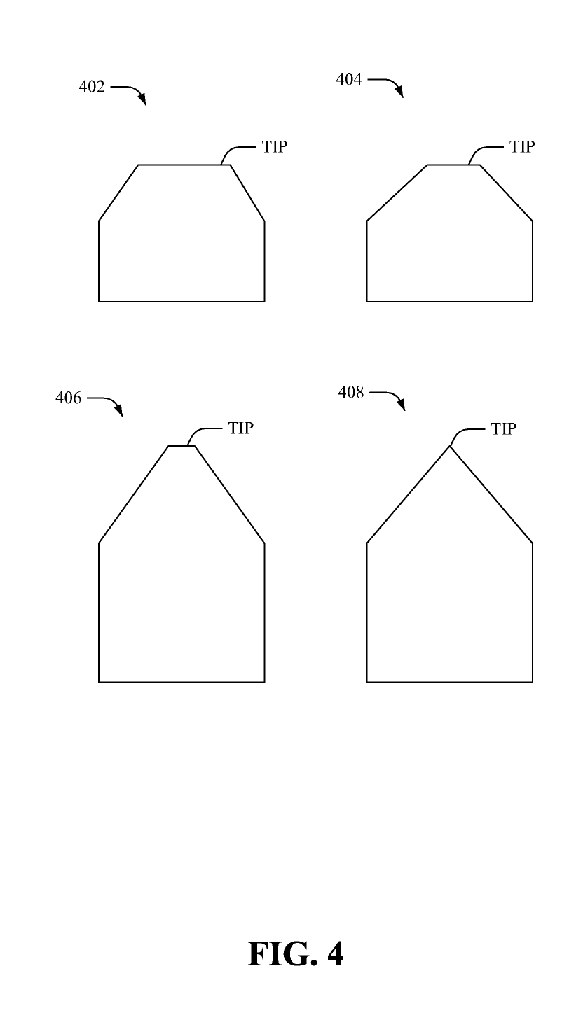

Referring now to FIG. 4, there illustrated are example pointing devices (402-408) that can be employed by a user while interacting with an electronic device, according to an aspect of the subject innovation. The electronic device can include, but is not limited to, a computer, a laptop computer, network equipment (e.g., routers, access points), a media player and/or recorder (e.g., audio player and/or recorder, video player and/or recorder), a television, a phone, a cellular phone, a smart phone, an electronic organizer, a PDA, a portable email reader, a digital camera, an electronic game (e.g., video game), an electronic device associated with digital rights management, a trusted platform module (TPM), a Hardware Security Module (HSM), set-top boxes, a digital video recorder, a gaming console, a navigation system or device (e.g., global position satellite (GPS) system), an electronic device associated with an industrial control system, an embedded computer in a machine (e.g., an airplane, a copier, a motor vehicle, a microwave oven), and the like or a combination thereof. The electronic device can typically employ a touch screen that employs capacitive sensors to detect interaction by the user. It can be appreciated that the pointing devices 402-408 can include functionality, as more fully described herein, for example, with regard to pointing device 102 in FIGS. 1-3.

Capacitive sensors can detect a touch based on the electrical conductance of the device that is touching the sensor. Typically, pointing devices 402-408 can be made of most any conductive material, such as, but not limited to silicon or conductive metals. According to an aspect, pointing devices 402-408 can be coated with a layer of the conductive material. Thus, when the pointing devices 402-408 touch a sensor, for example, located below a touch screen, the capacitance field of the sensors can be modified due to the capacitance of the pointing devices 402-408. Typically, an electronic circuit can measure a resultant distortion in the capacitance field of the sensors. Based on the data from the electronic circuit the location of the touch can be determined, for example by a controller and/or processor.

As can be seen from FIG. 4, various pointing devices 402-402 can be employed to interact with a capacitive sensor. The size and/or shape of pointing devices can vary based on the application. It can be appreciated that although only four different shapes have been depicted in FIG. 4, any other shape and/or size can be employed. Typically, the tip of the pointing devices 402-408 can be employed to touch a touch screen. In one example, only the tip of the pointing devices 402-408 can be coated with a conductive material. In particular, pointing device 402 is small can have a wide tip. Pointing device 404 has a tip that is narrower than the tip of pointing device 402. Further, pointing device 406 has a very narrow tip while the tip of the pointing device 408 is extremely pointed and narrow. The size of the tip can be changed based on the precision required. A narrow tip can improves precision of touch, allowing use of smaller interface elements.

Typically, the pointing devices 402-402 can be employed for selecting an icon on the touch screen. Further, the pointing devices 402-402 can also be employed for handwriting or drawing on the touch screen. It can be appreciated that pointing devices 402-402 can be attached to one or more fingers on either hand of a user. In one example, pointing devices of different shapes and/or sizes can be attached to different fingers, such that, the user can easily touch the screen with a pointing device of desired shape and/or size by employing a different finger. Furthermore, two or more of the pointing devices 402-402 can be employed by the user while touching a multi-input touch screen. The user can attach the same type of pointing device on two or more fingers or attach different types of pointing devices (e.g. 402-408) on two or more fingers to interact with a multi-input touch screen. The user can then select, move, pinch, grab, expand, press, compress one or more objects, by touching the object with multiple pointing devices (e.g. 402-408).

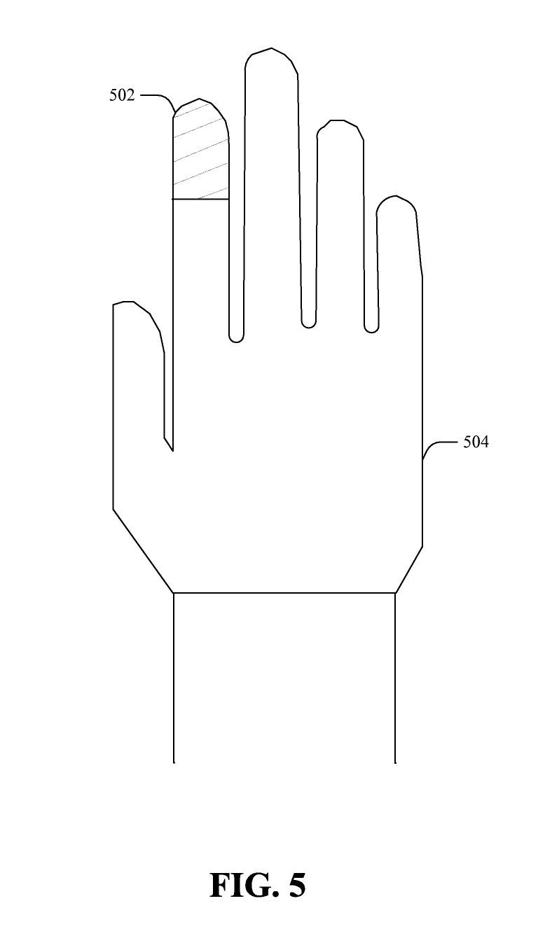

FIG. 5 illustrates an example conductive apparatus 502 that can be worn by user to interact with an electronic device in accordance with the subject innovation. Typically, the electronic device can employ a touch screen that can detect a touch based on a capacitive technique. Specifically, the touch screen can employ one or more capacitive sensors to detect the presence of a conductive element. Human skin exhibits conductive properties and thus the touch screen can detect an input by presence of skin. However, fingernails do not conduct electricity and thus cannot be employed to enter information on a conductive touch screen. Users with long fingernails cannot easily touch the touch screen with their finger. According to one aspect, the users can wear a conductive apparatus 502 over their finger while interacting with the touch screen.

Typically, the conductive apparatus 502 can be made of any conductive material. According to one aspect, the conductive apparatus 502 can fit smug over a finger. It can be appreciated that the conductive apparatus 502 can be worn on any finger on any hand of the user. In addition, the user can also wear multiple conductive apparatus 502 on multiple fingers on one or both hands. When the user touches the touch screen with a finger, the conductive apparatus 502 on the finger can generate a disturbance in capacitance and accordingly the presence and/or location of the finger can be detected.

According to another aspect, a user can be wearing a glove 504, for example, in an industrial area or in cold weather. Typically, the user cannot interact with a skin sensitive touch screen while wearing the glove 504 since the glove does not conduct electricity. Thus, the user can wear a conductive apparatus 502 on top of the glove 504 that can facilitate interaction with the touch screen. The conductive apparatus 502 can be worn on one or more fingers of the glove 504. When the user touches the touch screen while wearing the glove 504, the conductive apparatus 502 on the glove can create a change in capacitance that can be sensed by a sensor and accordingly the presence and/or location of the touch can be detected. It can be appreciated that the user can also connect a pointing device (102 FIG. 1) via an attaching device (104 FIG. 1) to a finger on the glove. Further, the conductive apparatus 502 can be permanently attached to the glove or temporarily worn on top of the glove while interacting with the electronic device.

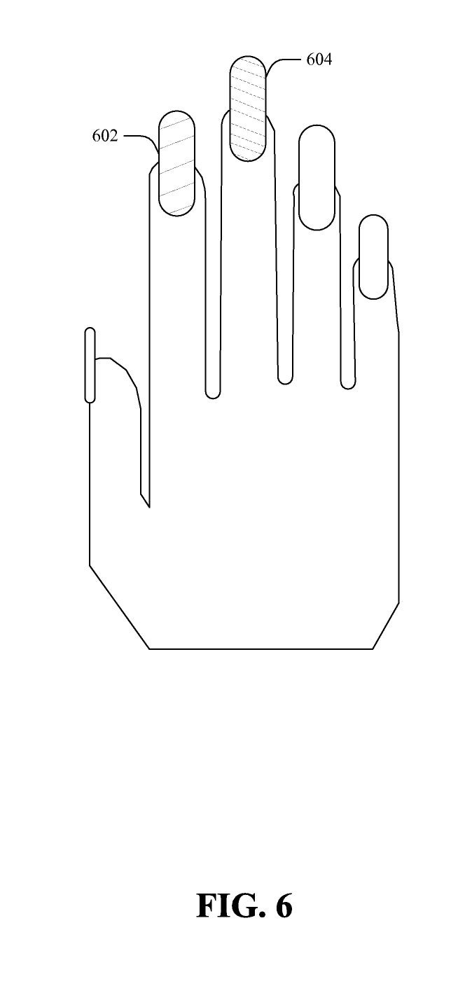

FIG. 6 illustrates example conductive fingernails (602-604) that can be employed by user to interact with an electronic device in accordance with an aspect of the disclosed subject matter. The electronic device can include, but is not limited to, an ATM, a self service kiosk, a computing device, a cellular phone, a media player and/or recorder, a GPS navigator, a PDA, a gaming device and/or a combination thereof that can employ a touch screen panel. According to an aspect, the touch screen panel can detect the presence and/or location of a touch based on a capacitive technology. Thus, the touch screen panel can detect contact made by an object that exhibits conductive properties.

Fingernails do not exhibit conductive properties and thus input is not received when the user touches the touch screen panel with a fingernail. According to an aspect, the user can employ a conductive fingernail 602 to input information onto the screen. The conductive fingernail 602 can be a fake fingernail that can be attached on top or in place of the user's fingernail. Further, the conductive fingernail 502 can be permanently or semi permanently attached to the users finger. By way of example and not limitation, the conductive fingernail 602 can be a fingernail extension that can be attached to the tip of the user's fingernail. Typically, the conductive fingernail 602 can exhibit conductive properties and can be made of and/or coated with a conductive material. When a user touches the touch screen with the conductive fingernail 602, the input can be detected by the electronic device. Specifically, the conductive fingernail 602 generates a change in a capacitive field on the touch screen on contact. The change in capacitance can be sensed and the input can be detected. It can be appreciated that although only one conductive fingernail 502 is depicted in the figure, a conductive fingernail can be employed on one or more fingers. Further, two or more conductive fingernails can be employed to enter data on a multi-input touch screen. It can be appreciated that the shape of the conductive fingernail 602 can be changed to improve precision.

According to another aspect, conductive fingernail paint can also be applied to a user's fingernail to facilitate conduction while touching the touch screen. A painted conductive fingernail 604 can input information to the electronic device via the skin sensitive touch screen. The skin sensitive touch screen can detect the presence and/or location of the point of contact of the painted conductive fingernail 604 on the screen based on a change in capacitance due to the contact. In one aspect, the conductive paint can be applied, for example, by a brush, to one or more fingernails.

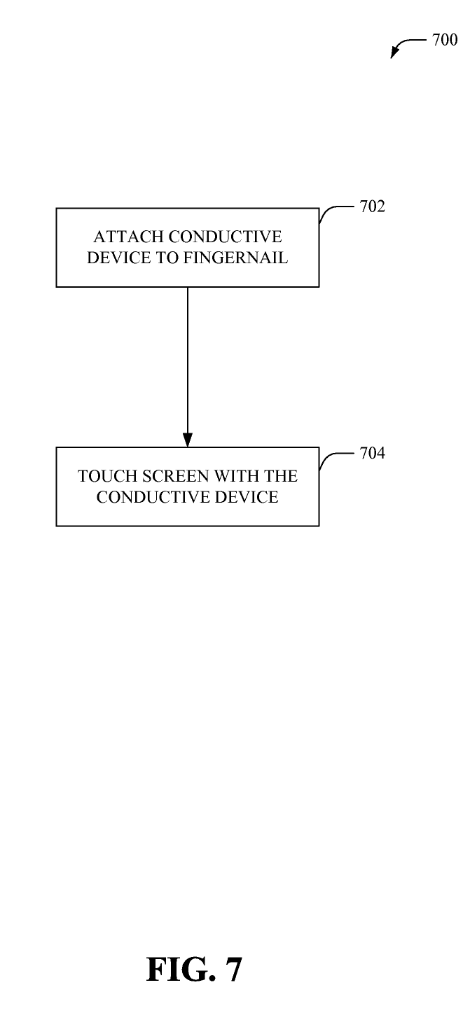

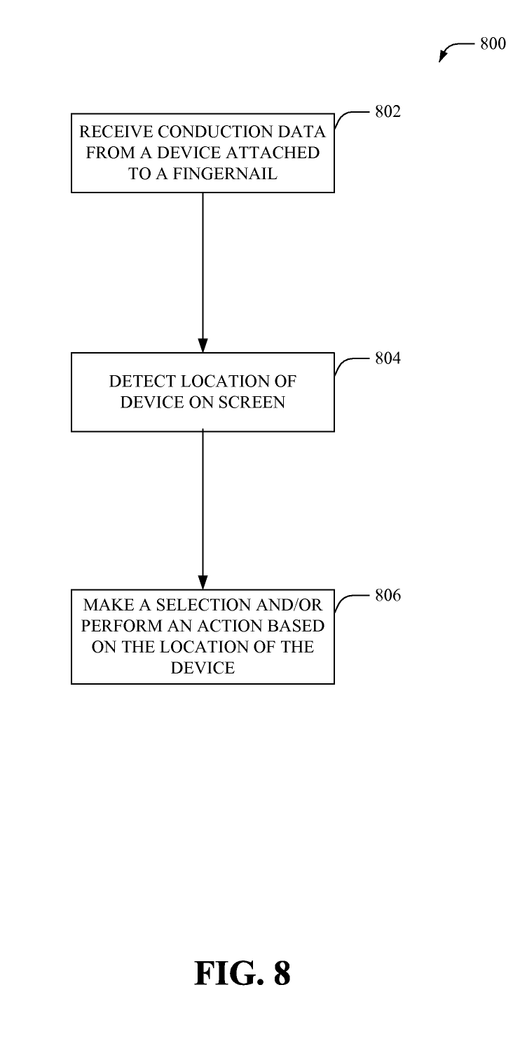

FIGS. 7-8 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 7, illustrated is an example methodology 700 that can be employed to interact with an electronic device via a capacitive touch screen, according to an aspect of the disclosed subject innovation. A user, for example, who has long fingernails, can employ methodology 700 to input information via the touch screen. At 702, a conductive device can be attached to the user's fingernail. According to an aspect, the conductive device can be made of most any conductive material and can be attached to the fingernail by most any permanent or temporary connection technique, such as but not limited to, sticking, clipping, covering etc. In one example, a fake conductive nail can be attached to a user's fingernail or the user's fingernail can be coated with a conductive material. At 704, the touch screen can be touched by employing the conductive device attached to the fingernail.

FIG. 8 illustrates an example methodology 800 that can be employed to receive data from a conductive fingernail in contact with a touch screen in accordance with an aspect of the disclosed subject innovation. At 802, conduction data can be received on the touch screen from a device attached to a user's fingernail. It can be appreciated that the device can be made of or coated with a layer of most any conductive material. According to one example, the device can be a fake fingernail made of a conductive material or the user's fingernail can be coated with a layer of conductive material. When the user touches the touch screen via the conductive device, a change in capacitance can be detected. At 804, location of the device on the touch screen can be determined based in part on the conduction data. Further, at 806, a selection can be made and/or an action can be performed based on the location of the device. For example, a user can touch a skin sensitive touch screen on a cellular phone by employing a conductive device attached to a fingernail. Specifically, the user can touch the device to an icon display on the screen, for example, a “Dial call” button. When the device touches the touch screen, conduction data can be received. Further, the location of contact of the device on the touch screen can be determined based on the conduction data. Furthermore, an action can be performed, for example, a phone number can be dialed, based on the location information.

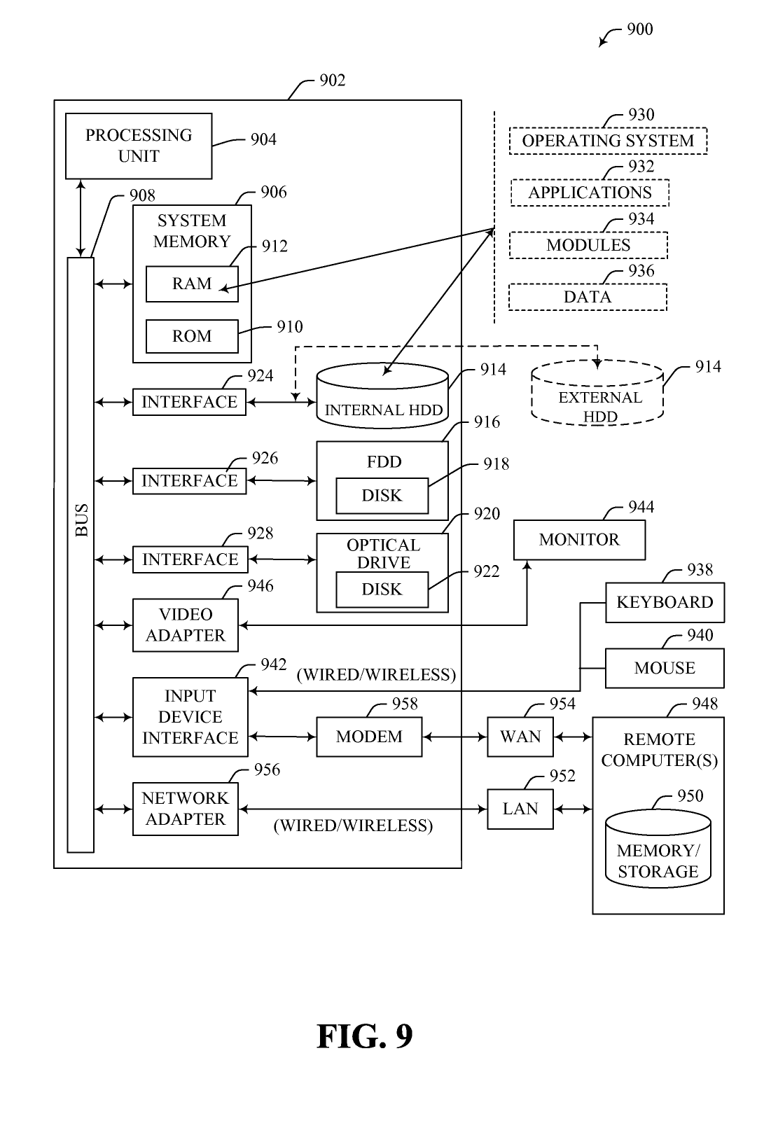

Referring now to FIG. 9, there is illustrated a block diagram of a computer operable to execute the disclosed architecture. In order to provide additional context for various aspects of the subject specification, FIG. 9 and the following discussion are intended to provide a brief, general description of a suitable computing environment 900 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the example environment 900 for implementing various aspects of the specification includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the specification can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are example and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An apparatus for interacting with an electronic device, comprising:
a pointing device that is attached to a user, the user touches a conductive touch screen associated with the electronic device via the pointing device to enter information on the electronic device.

2. The apparatus of claim 1, further comprising, an attaching device that connects the pointing device to the user.

3. The apparatus of claim 1, wherein, the pointing device is at least one of made of or coated with a conductive material.

4. The apparatus of claim 1, wherein, the pointing device is attached to the user's fingernail.

5. The apparatus of claim 1, wherein, the pointing device is permanently attached to the user.

6. The apparatus of claim 1, wherein, the pointing device is worn on top of at least one of a user's finger or a glove worn by the user.

7. The apparatus of claim 1, wherein, the pointing device is a conductive fingernail that is attached to a user's finger.

8. The apparatus of claim 1, wherein, the pointing device includes a conductive fingernail paint that is applied to a user's fingernail.

9. The apparatus of claim 1, wherein, at least one of a size or shape of the pointing device is selected based in part on the precision required during the interaction.

10. The apparatus of claim 1, wherein, two or more pointing devices are attached to two or more fingers of the user to facilitate interaction with a multi-input touch screen.

11. The apparatus of claim 1, wherein, the pointing device provides conductivity to the conductive touch screen at a point of contact with the conductive touch screen.

12. A method for entering data into an electronic device, comprising:
attaching a conductive device to a user's finger; and
touching a conductive touch screen associated with the electronic device via the conductive device to input data.

13. The method of claim 12, wherein, the conductive device is worn on top of at least one of the user's finger or a glove worn by the user.

14. The method of claim 12, wherein, the conductive device is a conductive fingernail that is attached to a user's finger.

15. The method of claim 12, wherein, the conductive device includes a conductive fingernail paint that is applied to a user's fingernail.

16. The method of claim 12, wherein, the conductive device provides conductivity to the conductive touch screen at a point of contact.

17. An apparatus that facilitates interaction with skin sensitive touch screen, comprising:
means for providing conductivity to the skin sensitive touch screen; and
means for attaching the means for providing conductivity to a user.

18. The apparatus of claim 17, wherein, the means for providing conductivity is attached to a user's fingernail.

19. The apparatus of claim 17, wherein, the user touches the skin sensitive touch screen via the means for providing conductivity.

20. The apparatus of claim 17, wherein, the means for providing conductivity is worn on top of at least one of a user's finger or a finger of a glove worn by the user.
